(19) United States
(12) Patent Application Publication
(10) Pub. No.: US 2005/0134858 A1
(43) Pub. Date: Jun. 23, 2005

(54) Optical droplet inspecting system and inspecting method therefor

(75) Inventors: Chien-Tsung Wu, Tachia Township (TW); Lung-Yu Hung, Nantou City (TW); Hung-Yueh Whang, Taipei City (TW)

Correspondence Address: BACON & THOMAS, PLLC, 625 SLATERS LANE, FOURTH FLOOR, ALEXANDRIA, VA, 22314, US

(73) Assignee: Phalanx Biotech Group, Inc., Hsinchu (TW)

(21) Appl. No.: 11/016,852

(22) Filed: Dec. 21, 2004

(30) Foreign Application Priority Data
Dec. 22, 2003 (TW) 092136415

(51) Int. Cl. G01J 3/44

(52) U.S. Cl. 356/432

(57) ABSTRACT

This invention discloses an optical droplet inspecting system and inspecting method therefor, including a transporter, a light source, a photodetector, a computer system, and a microarray having reagent solutions deposited. The microarray is mounted on the transporter, being positioned between the light source and the photodetector. The light source and the photodetector are simultaneously moved relative to the microarray to scan the images of these reagent solutions over the microarray. The images are transmitted to the computer system for analysis and comparison to verify whether each of the reagent solutions is properly spotted.

### BACKGROUND OF THE INVENTION

1. Field of the Invention

The present invention relates to a biochip inspecting platform, and in particular to an optical droplet inspecting system and inspecting method therefor.

2. Description of Related Art

There are a number of ways for depositing reagents on a biochip, including a contact type minuscule drop way and a non-contact type squirt way, for example. A droplet of reagent just deposited on the surface of the biochip is shaped as a three-dimensional drop. It is a general practice to proceed with a droplet deposition inspecting action for the deposited reagent solutions prior to washing the biochip so as to detect whether or not all the reagent solutions are correctly spotted. Several currently known methods for inspecting droplet deposition are briefly described as follows.

Referring to FIG. 1, U.S. Pat. No. 6,232,072 discloses an optical droplet inspecting method, wherein an optical fiber bundle 2 generates an incident light 4, irradiating droplets 8 and a photodetector 6 is used to receive signal light reflecting from or passing through the droplets 8 so as to inspect whether the droplet 8 is present. That is, the patent method uses changes in reflection angles resulting from light illumination onto the droplets to inspect whether or not the droplets 8 are correctly spotted. However, there is limited quantity of the droplets 8 for inspection at a time. Due to this incapability of large-scale inspection, inspection involves excessive time.

U.S. Pat. No. 6,558,623 also discloses an optical droplet inspecting method, wherein a light source and a photodetector are used to have a real-time inspection for the droplet deposition. The light source and the photodetector are arranged on the same side. Also, a reflection configuration is adopted to pick up the images of the droplets on a biochip. However, as the inspection has to be made simultaneously with the deposition, too much time is wasted. Production cost is thus too high for the current practice.

U.S. Pat. No. 5,601,980 discloses a droplet inspecting method by contact type deposition of droplets, wherein each of the droplets is inspected by a real-time optical manner when deposition is made. This method is not only a waste of time but is also inefficient. Although the teachings are capable of detecting the droplet deposition, only a small region such as a single droplet can be inspected at one time.

U.S. Pat. No. 6,587,579 discloses another droplet inspecting method; wherein an image set of a plurality of droplets adjacent to each other is obtained at a time to gradually build up the whole image of a biochip surface by a mapping algorithm. Thus, the overall droplet deposition can be determined. However, an apparatus having a powerful capability of calculation is necessary for forming the image of the biochip surface by using such a method. This method is time consuming, and not suitable for the processes of mass production.

There is accordingly a dire need for a method for speedily and efficiently inspecting the deposition state of quantities of droplets.

### SUMMARY OF THE INVENTION

An object of the present invention is to provide an optical droplet inspecting system and inspecting method therefor so as to speedily detect reagent solutions deposited on a biochip and simultaneously proceed with quality control.

Another object of the present invention is to provide an optical droplet inspecting system and inspecting method therefor so as to provide a simple and efficient detecting mechanism and reduce the cost of mass production.

An optical droplet inspecting system provided according to an aspect of the present invention is adapted to inspect a target specimen having reagent solutions deposited, comprising a transporter for transporting the target specimen, a light source for illuminating the target specimen, and a photodetector mounted on one side of the transporter to detect the reagent solutions on the target specimen, wherein the target specimen on the transporter is mounted between the photodetector and the light source so that the reagent solutions on the target specimen are illuminated by means of the light source and detected by means of the photodetector to obtain a result of the detection.

An optical droplet inspecting system provided according to another aspect of the present invention is adapted to inspect a target specimen having reagent solutions deposited, comprising a transporter for transporting the target specimen, a light source for illumination, a light guide plate for receiving irradiating light to illuminate the target specimen, and a photodetector mounted on one side of the transporter to detect the reagent solutions on the target specimen, wherein the target specimen on the transporter is mounted between the photodetector and the light guide plate so that the reagent solutions on the target specimen are illuminated by means of the light guide plate and detected by means of the photodetector to obtain a result of the detection.

An inspecting method for optical droplet inspecting systems provided according to another aspect of the present invention comprises the steps of providing a target specimen having reagent solutions deposited, and simultaneously moving a light source and a photodetector relative to the target specimen to scan the target specimen, wherein the target specimen is mounted between the photodetector and the light source so that the target specimen is illuminated by means of the light source and then the reagent solutions on the target specimen are detected by means of the photodetector to obtain a result of the detection.

An inspecting method for optical droplet inspecting systems provided according to another aspect of the present invention comprises the steps of providing a target specimen having reagent solutions deposited, and simultaneously moving a light source, a light guide plate and a photodetector relative to the target specimen to scan the target specimen, wherein the target specimen is mounted between the photodetector and the light guide plate so that the target specimen is illuminated with light from the light source by means of the light guide plate and then the reagent solutions on the target specimen are detected by means of the photodetector to obtain a result of the detection.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a conventional optical droplet inspecting method;

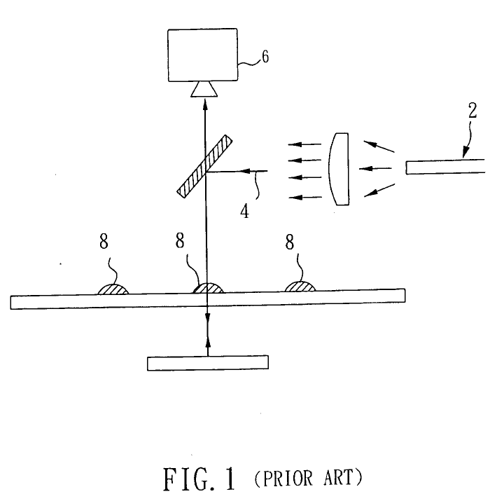

FIG. 2 is a schematic diagram of a systematic configuration of a first embodiment of an optical droplet inspecting system according to the present invention;

FIG. 3 is a schematic diagram of a systematic configuration of a second embodiment of an optical droplet inspecting system according to the present invention; and

FIG. 4 is a flowchart for illustration of an inspecting method for optical droplet inspecting systems according to the present invention.

### DETAILED DESCRIPTION OF THE PREFERRED EMBODIMENT

An optical droplet inspecting system and inspecting method therefor according to the present invention is adapted to measure data on the position, shape, size and diameter of a droplet just deposited on the surface of a chip so as to achieve quality control of fabrication biochips.

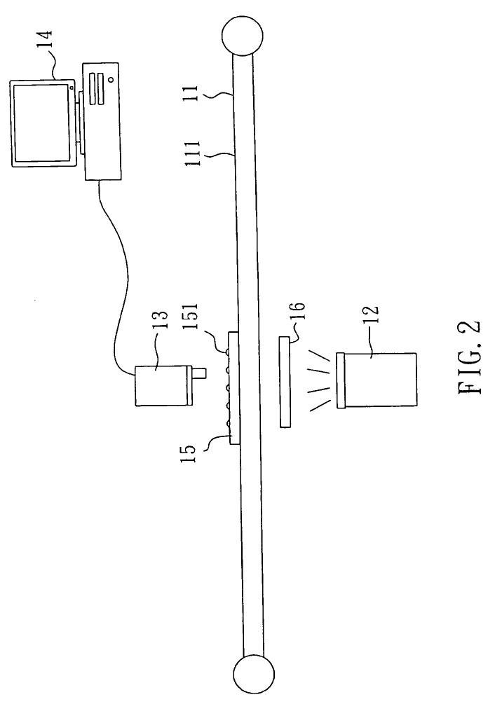

Referring now to FIG. 2, a systematic configuration of the first embodiment according to the present invention is schematically shown, comprising a transporter 11, a light source 12, a photodetector 13, a computer system 14, a microarray 15, and a light guide plate 16, wherein the microarray 15 has regent solutions 151 deposited thereon by squirt.

In this embodiment, the transporter 11 preferably is an apparatus having a transparent conveyor 111. Light emitting from the light source 12 is continuous. The light guide plate 16 is capable of converting the light continuously emitting from the light source 12 into linear light to be uniformly shined on the backside of the microarray 15 so as to be associated with the photodetector 13 for inspection by linear scan. The photodetector 13 is a digital camera, a CMOS (complementary metal-oxide semiconductor) sensor, or a Charge Coupled Device (CCD), and preferably, a line-scanning CCD. An optical droplet inspecting system and inspecting method therefor according to the present invention will be described, wherein the photodetector 13 preferably is a linear scanner used to continuously capture images in association with the operation of the light guide plate 16. It is clear that as the embodiment needs no light guide plate 16 if the photodetector 13 is a CCD, the system is low in cost.

The said microarray 15 is mounted on the transparent conveyor 11 of the transporter 11, being positioned between the photodetector 13 and the light guide plate 16. That is, the photodetector 13 is mounted above the microarray 15 for capturing the images of reagent solutions 151 on the surface of the microarray 15 while the light guide plate 16 is mounted below the transparent conveyor 111 and the microarray 15. Also, the light generated continuously by the light source 12 serves as a backlight light source so that the images captured by the photodetector 13 are clear. The reagent solutions contains biomolecules, which may be oligonucleotides, peptides or their derivatives.

The backlight light source adopted by the present invention is capable of providing the protuberant center of a droplet with a lens effect so that the image being captured appears as a dark ring with a bright center when light passes through the droplet, to allow for specific circumscription of the droplet and obtain precise data on the position, shape, size and diameter of the droplet. As a result, the deposition of each of the droplets can be verified with reference to the predetermined fabricating conditions.

The photodetector 13 is connected to the computer system 14 so that the images being captured are transmitted to the computer system 14 for analysis. The computer system 14 has quality control software installed and related database built-in to analyze the images so received. The images of the reagent solutions 151 captured by the photodetector 13 as well as the analysis of the images by the computer system will be described below.

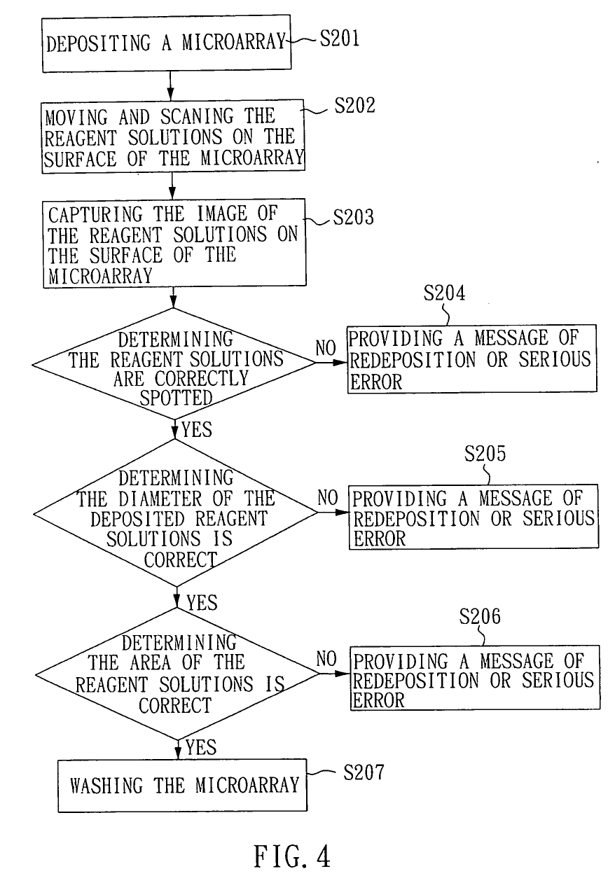

FIG. 4 shows a flowchart for the inspection of the surface of the microarray 15 according to the present invention. Reference is made to FIG. 4 together with the systematic configuration as shown in FIG. 2, the microarray 15 having reagent solutions deposited thereon is mounted on the transparent conveyor 111 of the transporter 11 at the beginning, wherein the quantity of the microarray 15 being mounted is not specifically defined in number (step S201).

The transporter 11 is then controlled to move the transparent conveyor 111 rightward so that the backlight light source and the photodetector 13 are simultaneously moved relative to the microarray 15 in order for the photodetector 13 to scan the reagent solutions 151 on the surface of the microarray 15 (step S202). Thus, the photodetector 13 will capture the images of the reagent solutions on the surface of the microarray 15 at a time, the images being transmitted to the computer system 14 for analysis (step S203).

The computer system 14 analyzes the detected images in accordance with the build-in database as well as the pre-installed analytic software. The computer system 14 initially compares the detected images with a predetermined image (for example, a perfectly deposited droplet image) to determine whether or not the deposited reagent solutions are correctly spotted. If a large quantity of the reagent solutions 151 (for example, twenty reagent solutions in quantity) is failed to be correctly spotted, the computer system 14 indicates a message of re-deposition or serious error (step S204); and simultaneously, the computer system 14 will gather statistics as to the quantity of irregular reagent solutions 151 to serve as reference parameters of an apparatus (not shown) for adjusting the deposition of the reagent solutions 151.

Then, the computer system 14 analyzes the diameter of the deposited reagent solutions 151 by comparing the diameter of the reagent solutions 151 with the predetermined droplet diameter stored in the database to verify whether the reagent solutions are properly deposited by the apparatus. If the reagent solutions 151 have a diameter significantly more or less than the predetermined droplet diameter and a significant quantity of such reagent solutions 151 (for example, twenty reagent solutions in number) occurs, the computer system 14 indicates a message of re-deposition or serious error (step S205).

Finally, the computer system 14 measures the area of the deposited reagent solutions 151 on the surface of the microarray 15 by comparing the area of the reagent solutions 151 with the predetermined area of a droplet stored in the database to verify whether the reagent solutions are properly deposited by the apparatus. If the area of reagent solutions 151 is significantly more or less than the predetermined area of a droplet and a significant quantity of such reagent solutions 151 (for example, twenty reagent solutions in quantity) occurs, the computer system 14 indicates a message of re-deposition or serious error. The computer system 14 also gathers statistics as to the diameter and area as a result of the analyses to obtain a plurality of parameters for adjusting the depositing apparatus. Accordingly such, all of the droplets to be deposited next can be made successfully at a time to optimize the deposition of these reagent solutions and increase deposition efficiency (step S206).

Hence, the computer system 14 analyzes the state of these reagent solutions 151 by comparing them with the predetermined value stored therein or the build-in database. Because the deposition of these reagent solutions 151 will affect the contact of the reagents in the reagent solutions 151 with the microarray 15, the deposition of the reagent solutions 151 can be verified in accordance with an inspecting method of the present invention before washing the microarray 15 to complete the fabricating processes for a biochip (step S207).

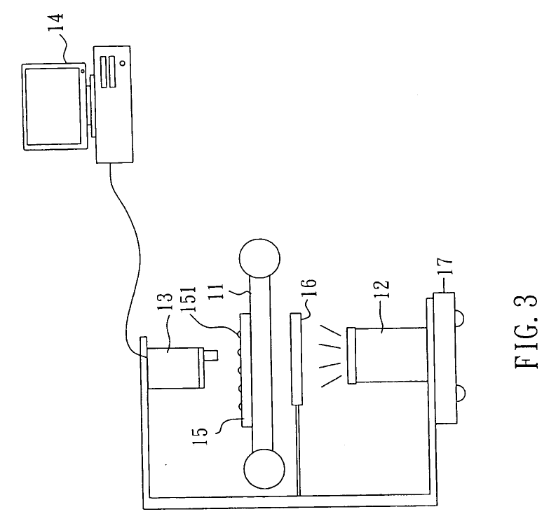

Turning now to FIG. 3, a systematic configuration of the second embodiment according to the present invention is schematically shown. This embodiment further comprises a displacement device 17, in addition to the transporter 11, the light source 12, the photodetector 13, the computer system 14, the microarray 15 and the light guide plate 16. The displacement device 17 is used to move the photodetector 13, the light source 12 and the light guide plate 16. The main differences between this embodiment and the first embodiment of the present invention reside in the transporter 11 being fixed to solely support the microarray 15, and the relative position among the photodetector 13, the light source 12 and the light guide plate 16 which remains unchanged so that the photodetector 13 is capable of scanning the reagent solutions 151 on the surface of the microarray 15 and the subsequent processes. Because the operating principle of the second embodiment of the present invention is similar to that of the first embodiment of the present invention and the flowchart for the inspection of the surface of the biochip 15 is similar to that of FIG. 3, this embodiment will not be depicted.

It is inferable from the above description that the present invention adopts a backlight-type optical scanning mechanism composed of a light source and a photodetector to inspect reagent solutions over a microarray and obtain a droplet image having an optimal resolution. The inspection according to the present invention proceeds in sequence, that is, the surface of at least one microarray is surveyed again after depositing the reagent solutions, and then images of the droplets are analyzed in accordance with predetermined values stored in the computer system or the build-in database of the computer system to verify the state of these reagent solutions, and then, a process for quality control (such as re-deposition and defect marking) is made in accordance with the result of such analyses to conduct real-time quality control. Thus, a simple and efficient inspecting mechanism is provided to achieve minimal fabrication cost.

Although the present invention has been explained in relation to its preferred embodiments, it is to be understood that many other possible modifications and variations can be made without departing from the spirit and scope of the invention as hereinafter claimed.

1. An optical droplet inspecting system adapted to inspect a target specimen having reagent solutions deposited, comprising:
a transporter for transporting said target specimen;
a light source for illuminating said target specimen; and
a photodetector mounted on one side of said transporter to detect said reagent solutions on said target specimen;
wherein said target specimen on said transporter is mounted between said photodetector and said light source so that said reagent solutions on said target specimen are illuminated by means of said light source and detected by means of said photodetector to obtain a result of the detection.

2. The optical inspecting system of claim 1, wherein said light source and said photodetector are simultaneously moved relative to said target specimen during detection to scan said reagent solutions on said target specimen.

3. The optical inspecting system of claim 1, wherein said photodetector is connected to an electronic device so as to output a result of the detection by said photodetector to said electronic device and indicate said result of the detection.

4. The optical inspecting system of claim 4, wherein said electronic device contains an analytical program of predetermined inspection values for analyzing said result of the detection received by said electronic device.

5. The optical inspecting system of claim 1, wherein said photodetector is connected to an electronic device storing predetermined inspection values for verifying the state of the droplets of said reagent solutions when said photodetector outputs said result of the detection to said electronic device.

6. The optical inspecting system of claim 5, wherein said predetermined inspection values are the diameter, area and position of a deposited droplet.

7. The optical inspecting system of claim 1, wherein said photodetector is a digital camera, a CMOS (complementary metal-oxide semiconductor) sensor, or a Charge Coupled Device.

8. The optical inspecting system of claim 1, wherein said result of the detection is the images of said reagent solutions on said target specimen.

9. The optical inspecting system of claim 1, wherein said reagent solutions contains biomolecules.

10. The optical inspecting system of claim 9, wherein said biomolecules are oligonucleotides, peptides or their derivatives.

11. An optical droplet inspecting system adapted to inspect a target specimen having reagent solutions deposited, comprising:
a transporter for transporting said target specimen;
a light source for illumination;
a light guide plate for receiving irradiating light to illuminate said target specimen; and
a photodetector mounted on one side of said transporter to detect said reagent solutions on said target specimen;
wherein said target specimen on said transporter is mounted between said photodetector and said light guide plate so that said reagent solutions on said target specimen are illuminated by means of said light guide plate and detected by means of said photodetector to obtain a result of the detection.

12. The optical inspecting system of claim 11, wherein said light source, said light guide plate and said photodetector are simultaneously moved relative to said target specimen during detection to scan said reagent solutions on said target specimen.

13. The optical inspecting system of claim 11, wherein said photodetector is connected to an electronic device so as to output a result of the detection by said photodetector to said electronic device and indicate said result of the detection.

14. The optical inspecting system of claim 13, wherein said electronic device contains an analytical program of predetermined inspection values for analyzing said result of the detection received by said electronic device.

15. The optical inspecting system of claim 11, wherein said photodetector is connected to an electronic device storing predetermined inspection values for verifying the state of the droplets of said reagent solutions when said photodetector outputs said result of the detection to said electronic device.

16. The optical inspecting system of claim 15, wherein said predetermined inspection values are the diameter, area and position of a deposited droplet.

17. The optical inspecting system of claim 11, wherein said photodetector is a line-scanning Charge Coupled Device.

18. The optical inspecting system of claim 17, wherein said light guide plate converts illuminating light into linear light to irradiate said target specimen.

19. The optical inspecting system of claim 11, wherein said result of the detection is the images of said reagent solutions on said target specimen.

20. The optical inspecting system of claim 11, wherein said reagent solutions contains biomolecules.

21. The optical inspecting system of claim 20, wherein said biomolecules are oligonucleotides, peptides or their derivatives.

22. An inspecting method for optical droplet inspecting systems, comprising the steps of:
providing a target specimen having reagent solutions deposited on the target specimen; and
simultaneously moving a light source and a photodetector relative to said target specimen to scan said target specimen;
wherein said target specimen is mounted between said photodetector and said light source so that said target specimen is illuminated by means of said light source; and then said reagent solutions on said target specimen are detected by means of said photodetector to obtain a result of the detection.

23. The inspecting method of claim 22, further comprising an analytical step of comparing said predetermined inspection values respectively with a result of the detection to obtain at least one result of the analytical determination on which a correspondingly subsequent process for said target specimen is based.

24. The inspecting method of claim 23, wherein said predetermined inspection values are the diameter, area and position of a deposited droplet.

25. The inspecting method of claim 24, wherein said predetermined inspection values are the diameter, area and position of a deposited droplet, and said target specimen is marked for reworking if said at least one result of the analytical determination indicates that the quantity of said reagent solutions incorrectly spotted is greater in quantity than a predetermined value.

26. The inspecting method of claim 22, wherein said photodetector is a digital camera, a CMOS (complementary metal-oxide semiconductor) sensor, or a Charge Coupled Device.

27. The inspecting method of claim 22, wherein said reagent solutions contains biomolecules.

28. The inspecting method of claim 22, wherein said biomolecules are oligonucleotides, peptides or their derivatives.

29. An inspecting method for optical droplet inspecting systems, comprising the steps of:
providing a target specimen having reagent solutions deposited; and
simultaneously moving a light source, a light guide plate and a photodetector relative to said target specimen to scan said target specimen;
wherein said target specimen is mounted between said photodetector and said light guide plate so that said target specimen is illuminated with light from said light source by means of said light guide plate; and then said reagent solutions on said target specimen are detected by means of said photodetector to obtain a result of the detection.

30. The inspecting method of claim 29, further comprising an analytical step of comparing said predetermined inspection values respectively with a result of the detection to obtain at least one result of the analytical determination on which a correspondingly subsequent process for said target specimen is based.

31. The inspecting method of claim 30, wherein said predetermined inspection values are the diameter, area and position of a deposited droplet.

32. The inspecting method of claim 31, wherein said predetermined inspection values are the diameter, area and position of a deposited droplet, and said target specimen is marked for reworking if said at least one result of the analytical determination indicates that the quantity of said reagent solutions incorrectly spotted is greater in quantity than a predetermined value.

33. The inspecting method of claim 29, wherein said photodetector is a line-scanning Charge Coupled Device.

34. The inspecting method of claim 29, wherein said reagent solutions contains biomolecules.

35. The inspecting method of claim 29, wherein said biomolecules are oligonucleotides, peptides or their derivatives.
